(19) United States
(12) Patent Application Publication
(10) Pub. No.: US 2010/0318268 A1
(43) Pub. Date: Dec. 16, 2010

(54) METHOD FOR CONTROLLING THE COMPRESSED AIR SUPPLY OF AN INTERNAL COMBUSION ENGINE AND TRANSMISSION

(75) Inventors: Thomas Jager, Meckenbeuren (DE); Christoph Ruchardt, Bodolz (DE); Roland Mair, Tettnang (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/867,306

(22) PCT Filed: Jan. 26, 2009
(86) PCT No.: PCT/EP09/50822

§ 371 Date: Aug. 12, 2010

(30) Foreign Application Priority Data
Feb. 18, 2008 (DE) 10 2008 000 324.7

(51) Int. Cl. B60W 10/10; F02D 23/00; B60W 10/06

(52) U.S. Cl. 701/54; 701/102

(57) ABSTRACT

A method to operate a vehicle drive train comprising a combustion engine, a turbo charger assigned to the combustion engine, a mechanism for injecting additional compressed air into an air intake system of the combustion engine and a transmission. The method enables practical use of a compressed air injection mechanism, in the drive train, and comprises the step of controlling the time, the duration, the pressure and/or the volume of the additional compressed air, to be injected into the air intake system of the combustion engine, depending upon the performance request of the driver, the actual rotational speed and load condition of the combustion engine, the speed of the vehicle, and the procedures of the gear ratio change of the transmission.

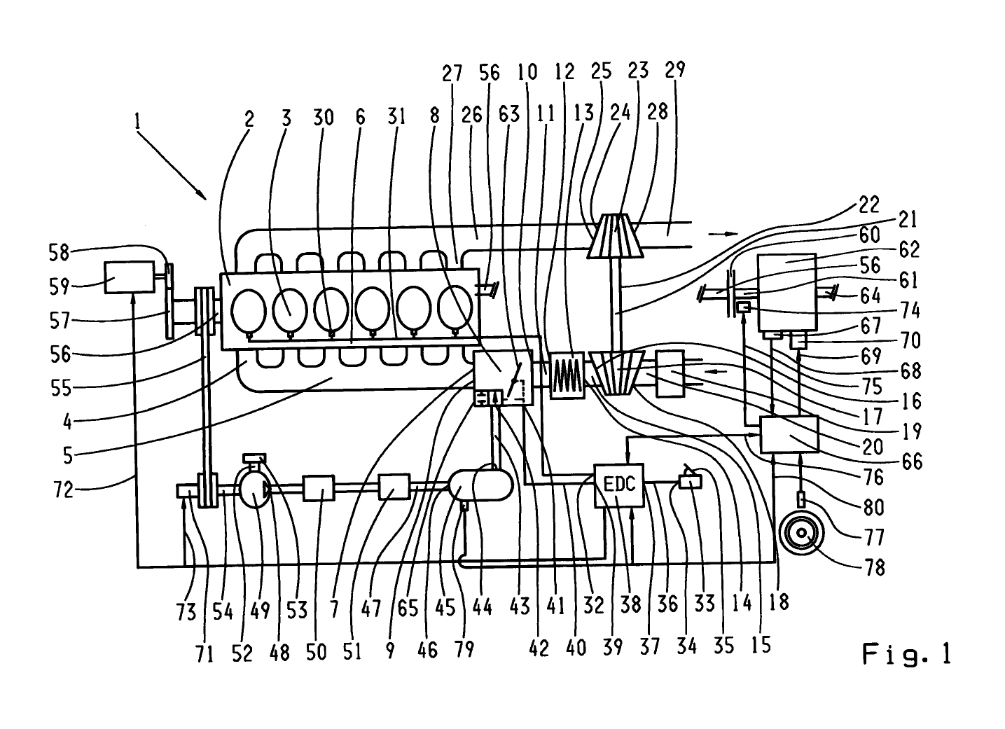

This application is a National Stage completion of PCT/EP2009/050822 filed Jan. 26, 2009, which claims priority from German patent application Ser. No. 10 2008 000 324.7 filed Feb. 18, 2008.

### FIELD OF THE INVENTION

The invention concerns a method to operate a vehicle drive train with a combustion engine, a turbo charger assigned to this combustion engine, a mechanism to inject additional compressed air into an air intake tract of the combustion engine, and a transmission.

### BACKGROUND OF THE INVENTION

It is known, for instance, through the patent applications WO 2006/037564 A1, WO 2006/089779 A1, and WO 2006/089780 A1 that a piston combustion engine, equipped with a turbo charger, generates at lower rotational speeds comparatively low torques, because the amount of air delivered, by a conventional turbocharger for a torque increase, into the intake tract of the motor depends, as determined by the system, on the particular exhaust flow of the combustion engine which drives the turbine of the turbo charger. This phenomenon, known as turbo lag, can be reduced in regard to characteristics of turbo chargers which have a variable geometry, in which the turbine blades, dependent of the available, driving exhaust gas stream, are designed as adjustable blades. Since the turbo chargers with variable geometry are comparatively expensive to manufacture and can only be driven through complex control and monitoring methods, the motor vehicle industry has a demand for simpler mechanisms and/or methods to achieve at a lower motor rotational speeds a relatively high drive torque of the combustion engine.

Based on this background, it is known through DE-PS-39 06 312, as well as through DE 199 44 946 A1, each presenting a method and a mechanism for a reduction of the so-called turbo lag, where during the acceleration of a diesel engine, equipped with a turbo charger, a certain amount of air from a compressed air container is injected into the suction pipe of the motor and where the amount of the injected fuel is matched accordingly. The required compressed air for the motor can hereby be taken from the compressed air storage of a compressed air brake system of a vehicle.

Also known from the earlier mentioned publications WO 2006/089779 A1 and WO 2006/089780 A1 is using a special mechanism as a fresh air supply or compressed air supply, respectively, for the reduction of the mentioned turbo lag in a turbo charged combustion engine. This mechanism, positioned in the intake area of the combustion engine, has an air inlet tract as a suction pipe, which has an adjustable throttle and a first end flange for the inflow of the intake air, as well as a second end flange for the outflow in the direction of the cylinders of the motor. The throttle is coupled to an adjustment device which can be driven by a control device for the adjustment. Positioned between the throttle and the second end flange is a compressed air connection with an opening which merges into the pipe-shaped interior of the mechanism. It is also provided that the compressed air connector interacts with a quantity control mechanism which has a valve with closed and randomly open positions, which can be driven via an electric input by an electric control device. The adjustment device of the throttle is forced to operate by the quantity control mechanism and/or the control device in a way, in case of a fully opened position of the throttle, that a fully closed position is assigned to the quantity control mechanism at that time.

To control the mechanisms for the compressed air injection into the intake tract of the combustion engine, known from the WO 2006/089779 A1 and WO 2006/089780 A1, the control device uses torque request signals which originate from the drive pedal, a traction control, a speed control system, and/or an electric stabilization program, or from means which pass on an external torque request to the engine control system.

It is also known from WO 2006/089779 A1 that, in case of the optimum control of the mechanism for the supply of the turbo charged combustion engine with compressed air—or as described therein with fresh gas—the control program of the control device in this mechanism knows predetermined parameters about the conditions, when an air injection has to be executed or terminated. For example, it can be taken into consideration that professional truck drivers or bus drivers each have individual drive habits, which require average acceleration parameters. Hence, such driver can prefer certain shift points when shifting the transmission. These can be recognized by the named control device, can be stored and processed. The data are used by the control device, for example, for determining the duration of the compressed air injection and for activating the throttle. It is intended, through this approach, to avoid the use of compressed air is unnecessarily and disadvantageously high. It is especially intended hereby that the duration of the compressed air injection and the activation of the throttle are controlled adaptively by the control software in relationship to the frequency of the request of the driver for acceleration.

Also known from WO 2006/037564 A1 is a generic mechanism where the compressed air, taken from the compressed air storage, can also be instantly supplied in front of the intake valve of a cylinder of the combustion engine.

Because the interaction of a generic mechanism for supplying a turbo charged combustion engine with compressed air, in accordance with WO 2006/089779 A1 and the WO 2006/089780 A1, is relatively complex with other mechanisms in the vehicle drive train, an optimum use of such a mechanism requires in a motor vehicle, whether it is a commercial vehicle or passenger vehicle, special control methods which take the particular characteristics and requirements of these drive train components into consideration. Therefore, it is the task of this invention to present a method which controls the interaction of a mechanism for the supply of a combustion engine with additional compressed air, equipped with a turbo charger, with another drive train component.

### SUMMARY OF THE INVENTION

The solution of this task arises from the characteristics of the main claim, while advantageous, further embodiments of the method of this invention are indicated in the dependent claims.

The invention is based on the knowledge that it is necessary, for an optimal control of an actually known mechanism for the a supply of a turbo charged combustion engine with additional compressed air, to also consider the operational behavior of other mechanisms and/or aggregates which are present in a vehicle drive train. Thus, the present invention deals with the, optimal for the operation, interaction of a transmission with the mechanism for the supply of a turbo charged combustion engine with compressed air.

The term “transmission” is meant to cover all versions of transmissions, for instance also manual shift transmissions, automatic transmissions, power transmissions, double clutch transmissions, stepped automatic transmissions, and also continuous shift transmissions.

The phrase “mechanism for the injection of additional compressed air into an air injection tract of a combustion engine” is meant to cover all the previously mentioned mechanisms, independent of the fact whether the compressed air or the fresh gas, respectively, is taken from a compressed air container of a compressed air brake or from above the mechanism in the vehicle, or whether the compressed air is generated, conditioned as required, instantly by an electric motor operated air pump. The so-called mechanism comprises all required parts and aggregates for the operation.

Furthermore, the invention is suitable for all mechanisms for the supply of turbo charged combustion engines with compressed air, independent of whether the compressed air is injected into the intake tract far from the cylinders of the combustion engine, or whether the compressed air is injected directly in front of the inlet valve of such a cylinder and its respective inlet area.

Thus, the invention presents a method of operating a vehicle drive train with a combustion engine, a turbo charger assigned to this combustion engine, a mechanism for the injection of additional compressed air into an air intake tract of the combustion engine, as well as a transmission. In accordance with the invention, it is provided in this method that the time, the duration, the pressure, and/or the volume of the additional compressed air to be injected into the air intake tract of the combustion engine, is controlled subject to performance request of the driver, the actual rotation speed of the combustion engine, the load condition of the combustion engine, the speed of the vehicle, and the sequence of a gear ratio change of the a transmission. The load conditions of the combustion engine comprise operating conditions of the combustion engine in an acceleration or deceleration condition.

The mechanism for the supply of a combustion engine, equipped with an exhaust gas turbo charger, with additional compressed air enables many advantages in the performance control of a combustion engine. However, such an equipped vehicle can only be practically and meaningful operated if the characteristics of the transmission, installed in the vehicle drive train, and its gear ratio change activity are taken into consideration. This gear ratio change activity is usually determined as the change of the gear or its shifting into its neutral position. Regarding infinitely variable transmissions, it is meant that a gear ratio change exits the current gear ratio selection and reaches a new transmission gear ratio.

Due to the fact, in accordance with the invention that during sequences, such that a change of the gear ratio of the transmission, the duration, the pressure, and/or the volume of the additional compressed air, which needs to be injected into the air intake tract of the combustion engine and which is dependent on the performance request of the driver, the actual rotational speed of the combustion engine, the load condition of the combustion engine, and the speed of the vehicle are taken into account, it can be achieved, especially at a low rotational speeds of the combustion engine, that an added torque increase through an additional compressed air injection can also be used for the sequences in the transmission. The achieved advantages of the interaction of the transmission, of the combustion engine, and the mechanism for the injection of additional compressed air, affect mainly the increase of the speed and the comfort of gear ratio change sequences, or the shifting of the transmission, respectively, as presented in the following with the embodiments of the invention.

Based on a first, advantageous embodiment of the method, in accordance with the invention, a vehicle drive train equipped with an electronic control device for the control of a combustion engine, an electronic control device to control the mechanism for the injection of additional compressed air into the intake tract of the combustion engine, and an electronic control device for the control of the transmission (or a common electronic control device for the control of all or some of these drive train components), it is provided that the electronic control device for the control of the mechanism for the injection of additional compressed air constantly determines an actual information hereof and supplies information to other control boxes, or control devices, respectively, about the time interval and the pressure, or volume stream, respectively, at which the compressed air can be injected into the intake tract.

The information is ascertainable via sensors, positioned at a compressed air container, and through the control device, whereby this compressed air container can be one which is also utilized by a compressed air brake system of the vehicle, for instance a commercial vehicle. The provision of the named information preferably takes place via an electronic vehicle data network, for instance via a commonly known CAN-bus. Thus, also other control devices, or control boxes, respectively, of the vehicle can obtain the named information which finally allow a statement of when, at what time interval and at it which level, a torque increase of the combustion engine is possible through the injection of additional compressed air.

In accordance with another embodiment of the invention, it is provided that the transmission control device, which determines the information by means of suitable sensors in regard to which time interval can be used and at which pressure, or volume stream, respectively, the compressed air can be injected into the intake tract, and that it uses the information for the selection of the targeted gear for an acceleration increase or an acceleration decrease, as well as for the optimal execution of such a gear ratio change.

It can be provided in that context that the actual filling level and the actual pressure in the compressed air container of the mechanism for the injection of the additional compressed air is communicated to the transmission control device, and that, through the available information, it can be determined at which time interval and at which pressure, or volume stream, respectively, additional compressed air can be injected into the intake tract, and this information can be used for the determination of the target gear ratio, or targeted gear determination of the transmission.

Another embodiment of the invention provides that the electronic control device for the control of the mechanism for the injection of additional compressed air takes the effect into account, for the calculation of the actual, maximal, possible engine torque, in regard to pressure and duration of a possible compressed air injection and makes the result of the actual, maximal engine torque during a compressed air injection available to the transmission control device, for the planning and execution of gear ratio change procedures.

It can also be provided, during the interaction between the transmission control device and the control device of the compressed air injection, that the transmission control device determines whether, in connection with the preparation or the optimal execution of a gear ratio change of the transmission, the injection of additional compressed air into the intake tract of the combustion engine makes sense at all, and in case of a positive assessment, issues a command for a compressed air injection in regard to the timing, the pressure, and the duration of the compressed air injection to the control device of the injection mechanism.

Another embodiment provides that the command for the injection of additional compressed air into the intake tract is issued when the achievable engine torque, after a planned gear ratio change of the transmission, would not be sufficient without a compressed air injection, to accelerate the vehicle sufficiently in the targeted gear ratio.

Also, it can be provided that the transmission control device determines those transmission gear ratios, or gears, respectively, which are, with or without a compressed air injection, meaningfully adjustable in an actual operating condition of the combustion engine and the vehicle, and that the transmission control device selects those gear ratios, or gears, respectively, as targeted gear ratio, which represent the optimal, next to follow gear ratio of the transmission, when a compressed air injection is applied, in regard to fuel consumption or performance criteria.

It is also considered as an advantage, when it is provided, that the transmission control device, during a gear ratio change, commands the control device for the control of the mechanism for the injection of additional compressed air in a way and in consideration of the dynamic behavior of this compressed air injection mechanism and the combustion engine, that this combustion engine, after the gear ratio change, provides the maximum, available torque as fast as possible.

It is also advantageous, when it is provided, if the mechanism for the injection of the compressed air, during downshifting, is triggered early in a way so that, if the transmission is shifted into neutral, the combustion engine provides a sufficiently large torque to quickly achieve hereby, the next needed rotational speed for the targeted gear ratio, or targeted gear, respectively.

It is also meaningful to provide that the mechanism for the injection of the compressed air, when downshifting, is triggered early in a way so that, as soon as targeted gear ratio has been adjusted or the targeted gear in the transmission has been shifted, a respective, larger engine torque is available to achieve desired acceleration behavior of the vehicle.

To achieve fuel efficient or performance oriented drive of such an equipped vehicle, it is provided that the mechanism for the injection of compressed air is triggered during downshifting in a way so that a targeted increase of the next following engine torque is available after the completion of the shifting, to minimize a drop of acceleration to enable a larger next gear, to achieve fuel efficient drive performance at relatively low rotational speeds.

In another embodiment of the method, in accordance with the invention, it is provided, during an upshift and for the reduction of the acceleration-free, or acceleration reduced phase, respectively, in a change of the gear ratio of the transmission and for an increase of the felt shifting speed, that a command is immediately issued by the transmission control device, after the end of the upshift procedure, to the control device of the injection mechanism to inject additional compressed air into the intake tract of the combustion engine.

Finally, it is proposed as meaningful, for the operation of a vehicle in deceleration mode and during a road gradient in the drive direction, to provide in the control device the ability to activate, powered by the combustion engine, an air compressor, which can be coupled into the drive train for charging of the named compressed air container to increase braking performance in the vehicle drive train, which can be activated or coupled with the drive train at a point of time when the transmission control device has activated an acceleration downshift of the transmission.

Finally, it is useful for the operation of a vehicle in deceleration mode and during a road gradient in the drive direction, to provide in the control device the ability to activate an air compressor, that is powered by the combustion engine and which can be coupled in the drive train for charging of the named compressed air container is preventively activated or coupled in, respectively, at the point of time when the vehicle is preferably in the deceleration mode, so that the braking performance, as well as the fuel consumption, are further optimized.

### BRIEF DESCRIPTION OF THE DRAWINGS

In the following, the invention is explained in detail based on the example of an embodiment in the sole drawing, which schematically shows a relevant part of a known drive train 1.

### DETAILED DESCRIPTION OF THE PREFERRED EMBODIMENTS

Belonging to the drive train 1 is a diesel engine 2 with six cylinders 3 lined up in a row of the cylinder block 6 and equipped with a turbo compressor 17. The intake lines 4 of the cylinders 3 are connected to a manifold 5 which has a connection flange 7, to which an air intake system 8 with its second end flange 9 is connected for the outflow of air. The first end flange 10, for the intake of air, is coupled via a pipe 11 with the outflow opening 12 of an intercooler 13, where its intake opening 14 is coupled via a pipe 15 with the outflow opening 16 of the turbo compressor 17. Connected to the intake opening 18 of the turbo compressor 17 is an air filter 19 with a pipe 20. The turbo compressor 17 forms a part of the turbo charger 22, where its exhaust turbine 23 with its intake opening 24 is connected to the outflow opening 25 of the exhaust manifold 26. The turbo compressor 17 and the exhaust turbine 23 are attached to a pivoted shaft 21. The cylinders 3 are connected via the exhaust pipes 27 to the exhaust manifold 26 and the outflow opening 28 of the exhaust turbine 23 is connected with the exhaust pipe 29 to effect flow.

The fuel supply of the cylinders 3 takes place via the injection nozzles 30, and regulation takes place via the cable 31 of the first output 32 of the electronic control device (EDC) 38. Connected to the input 37 of the electronic control device 38 via the cable 36 is the output 34 of the electronic control device 33. The last named control device 33 is provided with an activation part which is designed in this example embodiment as the gas pedal 35. The electrical contact 39 of the electronic control device 38 is coupled, via the manifold cable 40, with the electrical contact 41 of the air intake system 8. The dotted control line at the air intake system 8 makes it clear that the electronic control device 38 as a servomotor—not shown here—for the activation of the throttle 63. The available amount of air intake of the diesel engine 2 can be adjusted through the throttle 63.

The air intake system 8 has a compressed air connector 42 which is connected, via the pipe 43, to the outflow connector 44 of a compressed air container 45. The feed connector 46 of the compressed air container 45 is connected to the compressed air connector 48 of an air compressor 49. Fitted into the pipe 47 are also a pressure regulator 50 and an air dryer 51. The compressed air compressor 49 has an intake port 52 which has an air filter 53. The shaft 54 of the compressed air compressor 49 is connected via a belt drive 55 with the main shaft 56 of the turbo charged diesel engine 2. The invention also covers such air compressors which are driven, for example, via the electronic control device 38 which drives an electro motor (not shown here).

The drawing also shows that the compressed air compressor 49 can be connected, via one of the named electronic control device 38, and a control cable 73 which triggers the clutch 71, with the belt drive 55 at the combustion engine 2, so that the compressed air compressor 49 is only activated by the control device 38 when the pressure in the compressed air container 45 has to be refilled. For determination of the actual pressure in the compressed air container 45, a pressure sensor 79 is there positioned, where its measured signal can be conducted via a sensor cable 80 to the control device 38 and/or to the transmission control device 66.

Activation of the compressed air compressor 49 takes place, in accordance with the invention advantageously when the vehicle is in the deceleration mode on a downwardly sloping road, and, due to the power consumption of the air compressor 49, it takes advantage of the braking effect of the drive train 1.

The single drawing also shows that the combustion engine 2 can be driven and started by an electromotive starter 59, where the starter with its pinion 58 meshes with a sprocket 57 of the flywheel of the combustion engine 2. The flywheel is attached to the sprocket 57 in a known way, positioned on the main shaft 56 of the combustion engine 2. The starter 59 is connected, via a control cable 72, with the electronic control device 38 of the injection mechanism for additional compressed air and can therefore be switched on or off by the control device 38.

Also, an electromagnetic control and regulating valve 65, which can be driven by the control device 38, is positioned in the pipe 43, through which an injection or blow-in of additional compressed air from the compressed air container 45 into the air intake system 8 is made possible, if it is meaningful, especially for the increase of the torque of the diesel engine 2. The control valve 65 is driven by the electronic control device 38 via the manifold cable 40, which branches in the area of the air intake system 8 in to a control cable (small dotted line) to drive the servo motor of the throttle 63, and into a control cable (large dotted line) to control the control valve 63.

The drawing also shows schematically that the combustion engine 2, on the output side, is connected in a rotationally fixed manner via its main shaft 56 with the input side of a starting and shifting clutch 60, while the output side of the starting clutch 60 is coupled with the transmission input shaft 61 of an automatic transmission 62. The starting clutch 60 is designed as an automatic operating clutch and therefore equipped with a clutch actuator 74, which is connected, via a control cable 75, with the transmission control device 66, also receiving the commands from it.

If it is required by the operating behavior of the diesel motor combustion engine 2, a torsion vibrational damper, not shown here, can also be positioned on the input side of the starting clutch 60, which is, however, commonly known. The automatic transmission 62 as an output shaft, which is linked with drive shafts (not shown) and a differential gear with the vehicle wheels 78.

The automatic transmission 62 is, in this present embodiment, designed as an automatic shifting transmission where its known gear actuators 70 are connected, via a control cables 69, with the transmission control device 66. By means of the gear actuators 70, the transmission gears can be shifted in a commonly known manner and general gear transmission ratio changes can be executed. Also the transmission control device 66 is connected, via sensor cables 68, with the sensors at the transmission 66, through which the transmission control device 62 determines the shifting relevant information. Such information contains initially the rotational speeds of the transmission input shaft 61 and the transmission output shaft 64, as well as displacement signals and/or position signals of the gear actuators 70. Also, via the transmission control device 66, and/or via the control device 38, and by means of a rotational speed sensor 77, which is positioned at the transmission output shaft 64, or at a vehicle wheel 78, the speed of the vehicle is determined, as well as the determination of the engine speed via a main shaft 56 of the combustion engine 2. On this basis and other available information, the procedures for the gear ratio changes in the automatic transmission 62 are prepared and executed.

The drive train 1 functions, in regard to the basic function of the system 8 for the fresh air supply of the diesel engine 2, as follows:

The cylinders 3 of the turbo charged diesel engine 2 are supplied with fresh gas via the intake lines 4, the manifold 5, the air intake system 8, the pipe 11, the intercooler 13, the pipe 15, the turbo compressor 17, and the air filter 19, if the engine rotational speed is constant. The exhaust gases exit the cylinders 3 via the exhaust pipes 27, the exhaust manifold 26, the exhaust turbine 23, and the exhaust pipe 29.

If the driver quickly steps on the gas pedal 35, to rapidly increase the engine torque, or the engine rotational speed, respectively, the diesel engine 2 requires more fuel and more fresh gas, or air, respectively, than shortly before. The additional fuel is fed into the cylinders 3, but the increase of the amount of fresh gas which is provided by the turbo charger 22, remains inadequate. Also, the engine rotational speed and the pressure of the fresh gas in the intake tract 8 is low, which in the interior is constantly determined by a pressure sensor (not shown) and transmitted to the electronic control device 38. At that operating state, the throttle 63 is fully opened. The electronic control device 38 now determines, by means of the control program, that the pressure in the interior of the air intake system 8 has not increased fast enough, and that an additional air injection needs to be executed.

The control program has predetermined data of the conditions and when an additional air injection has to begin. Initially, the throttle 63 will be adjusted to close and the compressed air injection is enabled through opening of the valve 65 of the compressed air container 45 into the air intake system 8. The duration of the air injection is also predetermined by the control program which considers the difference in pressure and the absolute pressure in the air intake system 8.

By means of the control program, it is intended to a initially prevent consumption of compressed air from the compressed air container 45, so that the safety of the brake and its compressed air brake system, connected to the compressed air container 45, is not negatively affected.

It can also be seen in the drawing that the transmission control device 66 is connected, via a data cable 76 of a CAN-bus, with the control device 38 of the mechanism for the injection of additional compressed air, whereby the latter can also be described as an engine control device. Between these two control devices 38, 66, in accordance with the invention, a constant exchange of information takes place whether an injection of additional compressed air should take place, and if yes, at which amount the injection of additional compressed air into the intake system 8 of the combustion engine 2 shall take place, to increase the engine torque and to support a transmission shifting.

Only through this exchange of information, the gear ratio change procedures or gear shifting, respectively, in the automatic transmission 62 are meaningfully executable in a vehicle where such a mechanism for the injection of additional compressed air into the air intake system 8 of the combustion engine 2 is implemented. In addition, an exact coordination of the control for the injection of additional compressed air into the intake system 8 of the combustion engine 2 and for the preparation and execution of gear ratio change procedures of the automatic transmission 62, enables advantageously operating modes of the vehicle drive train 1, which were so far impossible, which has been mentioned already previously in the text.

### REFERENCE CHARACTERS

1 Vehicle Drive Train
2 Combustion Engine, Diesel Engine
3 Cylinders
4 Intake Line
5 Manifold
6 Cylinder Block
7 Connection Flange
8 Air Intake System
9 Second End Flange, Outflow Area
10 First End Flange, Intake Area
11 Pipe
12 Outflow Opening
13 Intercooler
14 Intake Opening
15 Pipe
16 Outflow Opening
17 Turbo Compressor
18 Intake Opening
19 Air Filter
20 Pipe
21 Shaft
22 Turbo Charger, Exhaust Turbo Charger
23 Exhaust Turbine
24 Intake Opening
25 Outflow Opening
26 Exhaust Manifold
27 Exhaust Pipe
28 Outflow Opening
29 Exhaust Pipe
30 Injection Nozzle
31 Cable
32 Output
33 Control Unit
34 Output
35 Gas Pedal
36 Cable
37 Input
38 Electronic Control Unit
39 Contact
40 Manifold Cable
41 Contact
42 Compressed Air Connector
43 Pipe
44 Outflow Connector
45 Compressed Air Container
46 Feed Connector
47 Pipe
48 Compressed Air Connector
49 Compressed Air Connector
50 Pressure Regulator
51 Air Dryer
52 Intake Port
53 Air Filter
54 Shaft
55 Belt Drive
56 Main Shaft
57 Sprocket
58 Pinion of the Engine Starter
59 Engine Starter
60 Starting and Shifting Clutch
61 Transmission Input Shaft
62 Transmission, Automatic Transmission
63 Throttle
64 Transmission Output Shaft
65 Control and Regulating Valve
66 Transmission Control Device
67 Sensor at the Transmission
68 Sensor Cable
69 Control Cable to the Transmission Actuator 70
70 Actuator at the Transmission
71 Actuator at the Clutch of the Compressed Air Compressor
72 Control Cable to the Engine Starter
73 Control Cable to the Actuator 71
74 Clutch Actuator
75 Control Line to the Clutch Actuator
76 Data Cable, CAN-Bus
77 Rotational Speed Sensor
78 Vehicle Wheel
79 Pressure Sensor
80 Sensor Cable

1-15. (canceled)

16. A method of operating a vehicle drive train (1) which comprises a combustion engine (2), a turbo charger (22) assigned to the combustion engine, a mechanism for injecting additional compressed air into an air intake system (8) of the combustion engine (2) and a transmission (62), the method comprising the steps of:
controlling at least one of a time, a duration, a pressure, and a volume of the additional compressed air to be injected into the air intake system (8) of the combustion engine (2) depending on at least one of:
a performance request of a driver,
an actual rotational speed of the combustion engine (2),
a load condition of the combustion engine (2),
a speed of the vehicle, and
a procedure for changing gear ratios of the transmission (62).

17. The method according to claim 16, further comprising the steps of either controlling the combustion engine (2) of the vehicle drive train (1) with an electronic engine control device (38), controlling the mechanism for the injection of additional compressed air with the engine control device (38) and controlling the transmission (62) with an electronic transmission control device (66) or
controlling the combustion engine (2), the mechanism for the injection of additional compressed air and the transmission (62) with a common electronic control device;
constantly determining information about the mechanism for the injection of additional compressed air, via the engine control device (38), to control the mechanism for the injection of additional compressed air; and
providing the information about the mechanism for the injection of additional compressed air to other control devices, with the information relating to a time interval and one of a pressure and a volume flow at which the compressed air is injected into the intake system (8).

18. The method according to claim 17, further comprising the step of utilizing the information relating to the time interval and one of the pressure and the volume flow at which the additional compressed air is injected into the intake system (8), via a transmission control device (66), for selecting a targeted gear in either an acceleration upshift or an acceleration downshift, and for optimum execution of the gear ratio change.

19. The method according to claim 16, further comprising the step of receiving, with a transmission control device (66), further information about an actual fill level and an actual pressure in a compressed air container (45) of the mechanism for the injection of additional compressed air; and
concluding from the further information, the time interval and at least one of the pressure and the volume flow, additional compressed air is injected into the intake system (8), and using the further information for determining a targeted gear ratio, or for a targeted gear determination.

20. The method according to claim 16, further comprising the steps of considering with the electronic control device (38), an influence of an actual compressed air injection in regard to pressure and duration for the control of the mechanism for the injection of additional compressed air and for the calculation of an actual, maximal possible engine torque; and
providing a result of the actual, maximal possible engine torque at the compressed air injection to a transmission control device (66), for planning and executing the procedures for changing gear ratios.

21. The method according to claim 16, further comprising the steps of determining via a transmission control device (66), whether, in conjunction with a preparation or an optimal execution of a gear ratio change of the transmission (62), injection of additional compressed air into the intake system (8) of the combustion engine (2) is beneficial, and, if the determination is beneficial, issuing, via the transmission control device (66), a command to a control device (38) of the mechanism for injecting the compressed air injection specifying a time, a pressure and a duration of the compressed air injection.

22. The method according to claim 16, further comprising the steps of issuing a command for the injection of additional compressed air into the intake system (8) if, after a planned gear ratio change of the transmission (62), an achievable engine torque, without the air injection, would not be sufficient to accelerate the vehicle sufficiently in a targeted gear ratio.

23. The method according to claim 16, further comprising the steps of determining, via a transmission control device (66), either the transmission gear ratios, or gears, which, either without or with a compressed air injection, are adjustable in an actual operating condition of the combustion engine (2) and the vehicle, and selecting with the transmission control device (66), the transmission gear ratios, or the gears, as a targeted gear ratio which represent, when an additional pressured air injection is used, an optimal, next gear ratio, with regard to fuel consumption and performance criteria.

24. The method according to claim 16, further comprising the step of issuing a command, with the transmission control device (66) during a gear ratio change, to a control device (38) of the mechanism for the injection of additional compressed air such that, based upon dynamic behavior of the mechanism for the injection of additional compressed air and the combustion engine (2), the combustion engine provides a maximum available torque as soon as possible after the gear ratio change.

25. The method according to claim 16, further comprising the steps of triggering the mechanism for the injection of additional compressed air early, when downshifting, such that, as soon as the transmission (62) is shifted into neutral, the combustion engine (2) provides a sufficient level of torque to quickly reach a subsequent rotation speed for either a targeted gear ratio or a targeted gear.

26. The method according to claim 16, further comprising the steps of triggering the mechanism for the injection of additional compressed air, when downshifting, such that when either a targeted gear ratio in the transmission (62) has been adjusted, or a targeted gear has been shifted, a high enough engine torque is present so that a requested acceleration behavior of the vehicle is achievable.

27. The method according to claim 16, further comprising the steps of triggering the mechanism for the injection of additional compressed air, when downshifting, such that a targeted increase of a subsequent engine torque, after completion of the gear ratio change, is present to minimize a dip in acceleration and provide fuel efficient drive for a next higher gear at a lower engine rotational speed.

28. The method according to claim 16, further comprising the steps of issuing a command to a control device (38) of the air injection mechanism for the injection of additional compressed air into the intake system (8) of the combustion engine (2) during an upshift procedure and for reduction of either an acceleration free or an acceleration reduced phase, during a gear ratio change of the transmission (62) and for an increase of shift speed of a transmission control device (66) after completion of the upshift procedure.

29. The method according to claim 16, further comprising the steps of activating an actuator (71), which is clutched into the drive train (1), and an air compressor (49), driven by the combustion engine (2) for charging a compressed air container (45) to increase either a braking effect of the drive train (1), or clutch in, when a transmission control device (66) has activated a deceleration downshift of the transmission (62).

30. The method according to claim 29, further comprising the steps of activating the air compressor (49) for the charging the compressed air container (45), when operating the vehicle in a deceleration mode and on a slope in a drive direction, to further increase the braking effect and further optimize fuel consumption.
